(19) United States
(12) Patent Application Publication
(10) Pub. No.: US 2024/0199233 A1
(43) Pub. Date: Jun. 20, 2024

(54) METHOD FOR MANUFACTURING AN AIRCRAFT WINDOW FRAME COMPRISING SEAMS OFFSET FROM A VISIBLE SURFACE, WINDOW FRAME OBTAINED FROM THIS METHOD AND AIRCRAFT COMPRISING AT LEAST ONE SUCH WINDOW FRAME

(71) Applicants: Airbus Operations SAS, TOULOUSE (FR); Airbus Operations S.L., GETAFE (ES)

(72) Inventors: Asuncion BUTRAGUENO-MARTINEZ, GETAFE (ES); Rodolphe TROUVE, TOULOUSE (FR); Patrice ARTIGUES, MASSIEUX (FR)

(21) Appl. No.: 18/538,454

(22) Filed: Dec. 13, 2023

(30) Foreign Application Priority Data
Dec. 15, 2022 (FR) 2213483

(51) Int. Cl. B64F 5/10; B64C 1/14

(52) U.S. Cl. CPC B64F 5/10; B64C 1/1492

(57) ABSTRACT

A method for manufacturing an aircraft window frame, the frame including a first surface that has a curved joining zone extending about the entire perimeter of the frame, this latter being made of composite material and including a stack of fiber layers, as well as at least one reinforcement positioned in the joining zone. The manufacturing method includes a step of assembling the different fiber layers and the reinforcement during which at least a first seam is made to join at least the reinforcement and some layers, the first seam including stitches offset from the first surface. A window frame is provided using this method, as well as an aircraft including the frame.

### CROSS-REFERENCES TO RELATED APPLICATIONS

This application claims the benefit of the French patent application No. 2213483 filed on Dec. 15, 2022, the entire disclosures of which are incorporated herein by way of reference.

### FIELD OF THE INVENTION

The present application relates to a method for manufacturing an aircraft window frame comprising seams offset from a visible surface, a window frame obtained using the method, and an aircraft comprising at least one such window frame.

### BACKGROUND OF THE INVENTION

According to an embodiment from the prior art shown in FIGS. 1 and 2, the fuselage 10 of an aircraft comprises a wall 12 having an external face 12.1 and an internal face 12.2, as well as a plurality of windows 14.

At each window 14, the wall 12 comprises an opening 16 delimited by an edge 16.1 joining the external face 12.1 and the internal face 12.2. As shown in FIG. 3, each window 14 comprises a surround 18 supporting two transparent walls 20, 20′ and a peripheral seal 22. The surround 18 comprises a first frame 18.1 joined to the wall 12 and a second frame 18.2 joined to the first frame 18.1 by joining elements 18.3, the transparent walls 20, 20′ and the peripheral seal 22 being interposed between the first and second frames 18.1, 18.2.

The first frame 18.1 comprises a first portion 26 positioned in the opening 16, a second portion 28 pressed against the internal face 12.2 of the wall 12 of the fuselage, an intermediate portion 30 joining the first and second portions 26, 28, and a third portion 32 joined to the second portion 28 and substantially perpendicular to this latter, the second frame 18.2 bearing against the third portion 28. According to one configuration, the intermediate portion 30 is positioned at a first end of the second portion 28 and the third portion 32 is positioned at a second end of the second portion 28 and forms an L-shape with this latter. Once the surround 18 has been mounted, the first portion 26 has an external face 26.1 flush with the external face 12.1 of the wall 12 of the fuselage and an internal face 26.2 substantially parallel to the external face 26.1. The second portion 28 comprises an external face 28.1 pressed against the internal face 12.2 of the wall 12 of the fuselage and offset inward from the external face 26.1 of the first portion 26, and an internal face 28.2 substantially parallel to the external face 28.1. The intermediate portion 30 has an external face 30.1 joining the external faces 26.1, 28.1 of the first and second portions 26, 28, as well as an internal face 30.2 joining the internal faces 26.2, 28.2 of the first and second portions 26, 28.

Thus, the first frame 18.1 comprises:
a first surface S1 comprising the external faces 26.1, 28.1, 30.1 of the first and second portions 26, 28 as well as of the intermediate portion 30,
a second surface S2 comprising the internal faces 26.2, 28.2, 30.2 of the first and second portions 26, 28 as well as of the intermediate portion 30.

Geometrically, the joining zone 33 joining the external faces 26.1, 30.1 of the first portion 26 and of the intermediate portion 30 has a pronounced curve so that the external face 30.1 of the intermediate portion 30 is substantially parallel to the edge 16.1 of the opening 16 and slightly spaced apart from the edge 16.1. This geometry helps to limit aerodynamic disturbances.

According to one embodiment, the first frame 18.1 is made as a single part from composite material and comprises reinforcing fibers embedded in a resin matrix.

As shown in FIGS. 4 and 5, the first frame 18.1 comprises fiber layers 34, 34′, 34″, reinforcements 36, a layer 38 of conductive material, and seams 40 to hold the layers 34, 38 and the reinforcements 36 assembled together. By way of example, the layer 38 of conductive material is a copper mesh that provides a lightning-protection layer.

According to an embodiment shown in FIG. 5, the first frame 18.1 comprises, from the first surface S1:
a layer 38 of conductive material that extends over the external face 26.1 of the first portion 26 and the very curved joining zone 33,
two fibers layers 34, 34′ that extend over the external faces 28.1, 30.1 of the second portion 28 and of the intermediate portion 30, and over the very curved joining zone 33,
a reinforcement 36 having a D-shaped cross section positioned in the very curved joining zone 33.

In general, the first frame 18.1 comprises other fiber layers 34″, the reinforcement 36 being interposed between the fiber layers 34′, 34″.

As shown in FIG. 5, the seams 40 join at least the first and second fiber layers 34, 34′ and the reinforcement 36, and are positioned in the first and second portions 26, 28 as well as the intermediate portion 30.

Once the seams 40 have been installed, assembly of the fiber layers 34, the reinforcements 36 and the layer 38 of conductive material is consolidated or polymerized. During this consolidation or polymerization step, the fibers in the different fiber layers 34, 34′ are embedded in a thermosetting resin during a resin transfer molding process.

On completion of the consolidation or polymerization step, the first frame 18.1 has resin accumulation zones on the first surface S1 about the seams 40 and about the very curved joining zone 33 on account of the presence of the reinforcement 36 with a D-shaped cross section. Thus, on account of this sporadic excess resin, the external face 26.1 of the first portion 26 of the first frame 18.1 does not exhibit uniform behavior, notably in the very curved joining zone 33.

On completion of assembly of the aircraft, and notably after installation of the windows 14, the external face 12.1 of the wall 12 of the fuselage is covered with at least one paint layer that also covers the external face 26.1 of the first portion 26 of the first frame 18.1 of each window 14.

The non-uniform behavior of the external face 26.1 of the first portion 26 of the first frame 18.1 may result in a visual modification of the paint.

The present invention is intended to overcome some or all of the drawbacks in the prior art.

### SUMMARY OF THE INVENTION

For this purpose, the invention relates to a method for manufacturing an aircraft window frame, the frame comprising a first surface that has at least first and second faces extending about the entire perimeter of the frame, the first and second faces being joined by a curved joining zone, the frame being made of a composite material comprising fibers embedded in a resin matrix, the manufacturing method comprising a step of assembling a reinforcement and a stack comprising a first layer positioned on the first surface and internal layers, a step of consolidating or polymerizing the assembly, and a step of demolding the frame, the reinforcement having first and second peripheral edges, being interposed between the first layer on one side and the internal layers on the other side, and being positioned in the joining zone, the first layer and the internal layers extending on both sides of the reinforcement and being stacked on both sides of the reinforcement.

According to the invention, during the assembly step, at least a first seam is made to join at least the reinforcement and some layers, the first seam comprising stitches offset, in a direction perpendicular to the first surface, in relation to the first surface, at least in the first face and in the joining zone so that they do not reach the first surface and are not visible from the first surface.

The fact that the stitches of the first seam are offset in relation to the first surface, in the joining zone and the first face, prevents the resin from reaching the first surface by migrating along the threads of the first seam and forming sporadic accumulation zones. The external surface of the frame thus exhibits more uniform behavior and does not cause visual modifications to the paint.

According to another feature, the stitches of the first seam do not traverse any fiber layers between the reinforcement and the first surface at least in the first face.

According to another feature, the frame comprises at least one intermediate layer interposed between the first layer and the internal layers, the first seam traversing the reinforcement, the internal layers and at least one intermediate layer and not traversing the first layer.

According to another feature, during the assembly step, at least a second seam is made, offset from the joining zone and from the first face, the second seam comprising through-stitches visible from the first surface.

According to another feature, a barrier layer is positioned between the reinforcement and the first surface to cover the reinforcement and to form a barrier limiting the spread of resin toward the first surface.

According to another feature, the method comprises a step of sprinkling a resin between the fiber layers and heating to a temperature below a polymerization or consolidation temperature to activate the tack of the resin in order to keep the different layers bonded together before the consolidation or polymerization step.

The invention also relates to a frame comprising a first surface that has at least first and second faces that extend about the entire perimeter of the frame and that are joined by a curved joining zone, the frame being made of a composite material comprising fibers embedded in a resin matrix, the frame comprising a stack comprising a first layer positioned on the first surface and internal layers, as well as at least one reinforcement interposed between the first layer on one side and the internal layers on the other side, and positioned in the joining zone, the first layer and the internal layers extending on both sides of the reinforcement and being stacked on both sides of the reinforcement.

According to the invention, the frame comprises at least a first seam joining at least the reinforcement and some layers, the first seam comprising stitches offset, in a direction perpendicular to the first surface, in relation to the first surface at least in the first face and in the joining zone so that they do not reach the first surface and are not visible from the first surface.

According to another feature, the frame comprises at least a second seam offset from the joining zone and from the first face, the second seam comprising through-stitches visible from the first surface.

According to another feature, the stitches of the first seam do not traverse any fiber layers between the reinforcement and the first surface at least in the first face.

According to another feature, the frame comprises at least one intermediate layer interposed between the first layer and the internal layers, the first seam traversing the reinforcement, the internal layers and at least one intermediate layer and not traversing the first layer.

According to another feature, the frame comprises at least one barrier layer covering the reinforcement, positioned between the reinforcement and the first surface and designed to form a barrier limiting the spread of resin toward the first surface.

The invention also relates to an aircraft comprising at least one window frame according to one of the above features.

### BRIEF DESCRIPTION OF THE DRAWINGS

Further features and advantages will become apparent from the following description of the invention, which description is given solely by way of example, with reference to the appended drawings in which:

FIG. 1 is a side view of an aircraft,

FIG. 2 is a front view of a window,

FIG. 3 is a cross section, along the line III-III in FIG. 2, of a surround of a window illustrating one embodiment of the prior art,

FIG. 4 is a perspective view of a portion of a first window frame illustrating a first embodiment of the prior art,

FIG. 5 is a schematic cross section of a window frame illustrating an embodiment of the prior art,

FIG. 6 is a cross section of a surround of a window illustrating an embodiment of the invention,

FIG. 7 is a schematic cross section of a window frame illustrating an embodiment of the invention.

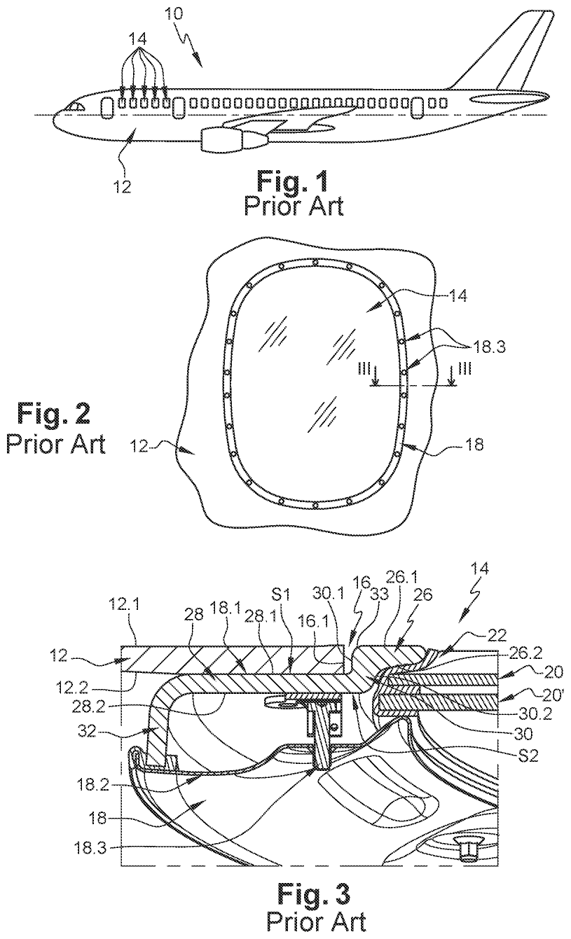

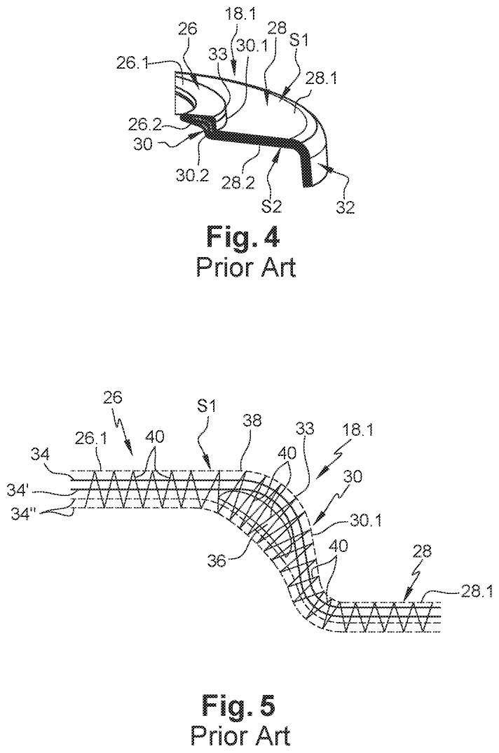

### DETAILED DESCRIPTION OF THE PREFERRED EMBODIMENTS

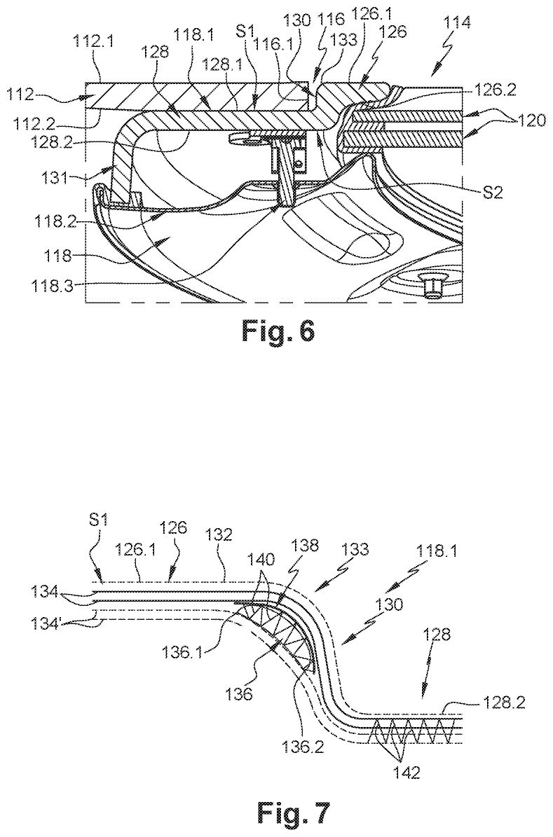

As shown in FIGS. 6 and 7, a fuselage wall 112 of an aircraft comprises an external face 112.1, an internal face 112.2 opposite the external face 112.1 and at least one window 114 positioned in an opening 116 delimited by an edge 116.1 joining the external and internal faces 112.1, 112.2. The window 114 comprises at least one transparent wall 120 and a surround 118 positioned about the transparent wall 120 and designed to join the transparent wall to the fuselage wall 112. This surround 118 comprises first and second frames 118.1, 118.2 between which the transparent wall 120 of the window 114 is positioned.

The first frame 118.1 comprises a first portion 126 intended to be positioned in the opening 116 in the fuselage wall 112 and a second portion 128 intended to be pressed against the internal face 112.2 of the fuselage wall 112.

When the surround 118 is positioned in an opening 116 in the fuselage wall 112, the first portion 126 comprises an external face 126.1 flush with the external face 112.1 of the fuselage wall 112 and an internal face 126.2 opposite the external face 126.1. The second portion 128 comprises an external face 128.1 pressed against the internal face 112.2 of the fuselage wall 112 and an internal face 128.2 opposite the external face 128.1.

According to one configuration, the first and second portions 126, 128 are directly joined. According to this configuration, the first portion 126 comprises a side face 130 facing the edge 116.1 of the opening 116 in the fuselage wall 112.

According to another configuration, the first frame 118.1 comprises an intermediate portion, joining the first and second portions 126, 128, that has a side face 130, joining the external faces 126.1, 128.1 of the first and second portions 126, 128, designed to face the edge 116.1 of the opening 116 in the fuselage wall 112.

The first frame 118.1 may comprise other portions, such as a third portion 131 joined to the second portion 128 and substantially perpendicular to this latter, the second frame 118.2 of the surround 118 bearing against this third portion 131 when in operation.

According to these configurations, the first frame 118.1 comprises a first surface S1 that comprises at least the external faces 126.1, 128.1 of the first and second portions 126, 128 and the side face 130, joining the external faces 126.1, 128.1, designed to face the edge 116.1 of the opening 116 in the fuselage wall 112.

Geometrically, the first surface S1 of the first frame 118.1 comprises a joining zone 133, joining the external face 126.1 of the first portion 126 and the side face 130, which has a pronounced curve so that the side face 130 is substantially parallel to the edge 116.1 of the opening 116 in the fuselage wall 112 and slightly spaced apart from the edge 116.1. This geometry helps to limit aerodynamic disturbances.

Regardless of the embodiment, a window 114 of a fuselage wall 112 of an aircraft comprises at least one frame 118.1 comprising a first surface S1 that extends about the entire perimeter of the frame 118.1.

This first surface S1 has at least first and second faces that extend about the entire perimeter of the frame 118.1 and are joined by a curved joining zone 133 that also extends about the entire perimeter of the frame 118.1. The first surface S1 may comprise other faces. The first face is the external face 126.1 of the first portion 126 of the frame 118.1. It is substantially flat and visible from the outside of the aircraft when the window 114 is positioned in the opening 116 in the fuselage wall 112. When the frame 118.1 is positioned in an opening 116 in the fuselage wall 112, the first face 126.1 is flush with the external face 112.1 of the fuselage wall 112. The second face is the side face 130. This face is substantially perpendicular to the first face 126.1. The joining zone 133 has a pronounced curve.

According to one embodiment, the frame 118.1 is made as a single part from composite material and comprises fibers embedded in a resin matrix. Preferably, the resin is a thermosetting resin.

As illustrated in FIG. 7, the frame 118.1 comprises fiber layers 132, 134 and at least one reinforcement 136 positioned in the joining zone 133.

This reinforcement 136 extends about the entire perimeter of the frame 118.1 and has a D-shaped cross section. It extends between the first and second peripheral edges 136.1, 136.2. This reinforcement 136 may be an optionally pre-impregnated fiber preform. It is not described further since it can be identical to those found in the prior art.

The frame 118.1 may comprise other reinforcements.

According to one embodiment, the frame 118.1 comprises, from the first surface S1:
a first layer 132 of dry fibers on the first surface S1, which covers the whole of the first surface S1,
intermediate layers 134 of dry fibers positioned beneath the first layer 132, which covers the whole of the first surface S1,
a reinforcement 136 with a D-shaped cross section, positioned in the very curved joining zone 133.

In general, the frame 118.1 comprises internal layers 134′ of dry fibers, the reinforcement 136 being interposed between the intermediate and internal layers 134, 134′.

According to a simplified variant, the frame 118.1 does not have any intermediate layers 134 between the first layer 132 and the reinforcement 136. According to one configuration, the frame 118.1 comprises a single intermediate layer 134 between the first layer 132 and the reinforcement 56.

The first layer 132 covers the reinforcement 136 and extends on both sides of same, beyond the first and second peripheral edges 136.1, 136.2. According to one configuration, the first layer 132 covers the whole of the first face corresponding to the external face 126.1 of the first portion 126. It may also cover the whole of the second face corresponding to the side face 130.

The intermediate layers 134 cover the reinforcement 136 and extend on both sides of same, beyond the first and second peripheral edges 136.1, 136.2. According to one configuration, the intermediate layers 134 cover the whole of the first face corresponding to the external face 126.1 of the first portion 126. They may also cover the whole of the second face corresponding to the side face 130.

Regardless of the embodiment, the frame 118.1 comprises a stack comprising a first layer 132 positioned on the first surface S1 and internal layers 134′, the reinforcement 136 being interposed between the first layer on one side and the internal layers 134′ on the other side, the first layer 132 and the internal layers 134′ extending on both sides of the reinforcement 136 and being stacked on both sides of the reinforcement 136. According to one embodiment, the frame 118.1 comprises at least one intermediate layer 134 interposed between the first layer 132 and the internal layers 134′.

The fibers of the different layers 132, 134, 134′ are made of carbon. Naturally, the invention is not limited to this material.

The different layers 132, 134, 134′ may be woven or unwoven layers.

The different layers 132, 134, 134′ have fibers that may be oriented similarly or differently.

According to one embodiment, the frame 118.1 comprises at least one barrier layer 138 covering the reinforcement 136, interposed between the reinforcement 136 and the first surface S1 and designed to limit the spread of resin from the reinforcement 136 toward the first surface S1. The presence of this barrier layer 138 prevents, in the joining zone 133, the spread of resin toward the first surface S1 and the formation of sporadic resin accumulation zones. The external surface S1 of the frame 118.1 thus exhibits more uniform behavior and does not cause visual modifications to the paint.

According to one configuration, the frame 118.1 comprises a single barrier layer 138.

According to one arrangement, the barrier layer 138 is in contact with the reinforcement 136. The barrier layer is interposed between the reinforcement 136 and the intermediate layers 134.

According to a non-limiting configuration, the barrier layer 138 extends from the first peripheral edge 136.1 of the reinforcement 136 to the second peripheral edge 136.2 thereof. The barrier layer does not extend beyond the first and second peripheral edges 136.1, 136.2 of the reinforcement 136.

According to one embodiment, the barrier layer 138 comprises at least one fiberglass ply. Naturally, the invention is not limited to this material.

According to one configuration, the barrier layer 138 is a woven ply that has a fine mesh to limit the spread of resin through the barrier layer 138.

According to one feature of the invention, the frame 118.1 comprises at least a first seam 140 joining at least the reinforcement 136 and at least some layers, such as the barrier layer 138, the first seam 140 comprising a set of stitches that do not traverse any fiber layers 132, 134 between the reinforcement 136 and the first surface S1 at least in the first face (corresponding to the external face 126.1 of the first portion 126) and in the joining zone 133. Regardless of the embodiment, the stitches of the first seam 140 do not reach the first surface S1 and are offset in a normal direction (perpendicular to the first surface S1) in relation to this latter so that they are not visible from the first surface S1 at least in the first face 126.1 and in the joining zone 133. According to one configuration, the first seam 140 traverses the reinforcement 136 and the internal layers 134′ and does not traverse the first layer 132 and the intermediate layer 134. According to another configuration, the first seam 140 traverses the reinforcement 136 and the internal layers 134′ and at least one intermediate layer 134, and does not traverse the first layer 132.

The fact that the stitches of the first seam 140 are offset in relation to the first surface S1 (and remote therefrom), in the joining zone 133 and the first face, prevents the resin from reaching the first layer 132 by migrating along the threads of the first seam 140. This arrangement limits the spread of resin by migration toward the first surface S1 and the formation of sporadic resin accumulation zones. The first surface S1 of the frame 118.1, at least in the first face and in the joining zone, thus exhibits more uniform behavior and does not cause visual modifications to the paint.

According to an embodiment shown in FIG. 7, the frame 118.1 comprises at least a second seam 142 offset from the joining zone 133, from the first face corresponding to the external face 126.1 of the first portion 126, and preferably from the second face corresponding to the side face 130. This second seam 142 comprises through-stitches (stitches that traverse all of the fiber layers 132, 134, 134′) that are visible from the first surface S1.

Unlike in the prior art, the frame 118.1 does not include a layer of conductive material covering the first layer 132 of dry fibers at least in the first and second faces (corresponding to the external face 126.1 of the first portion 126 and to the side face 130) and in the joining zone 133. Thus, the surface S1 has a uniform appearance in these zones.

The method for making the frame 118.1 comprises a step of assembling the different layers 132, 134, 134′, the reinforcement 136 and the barrier layer 138 by superposing them. During this assembly step, at least one barrier layer 138 can be positioned between the reinforcement 136 and the first surface S1 to cover the reinforcement 136 and to form a barrier limiting the spread of resin toward the first surface S1. During the assembly step, at least a first seam 140 is made to join the reinforcement 136 and the barrier layer 138 assembled together. This first seam 140 comprises stitches that are not visible from the first surface S1 and are remote from this latter to limit the spread of resin toward the first surface S1. In a variant, to keep the different layers 132, 134, 134′ bonded together before they are polymerized or consolidated, the method comprises a step of sprinkling a resin between the layers and heating to a temperature, in the order of 80° C., below a polymerization or consolidation temperature to activate the tack of the resin. It is thus no longer necessary to provide seams.

The method then comprises a step of consolidating or polymerizing a resin, the assembly of the different layers 132, 134, 134′, the reinforcement 136 and the barrier layer 138 being positioned on a mold and covered by at least one fluid tight flexible envelope joined sealingly to the mold about the entire assembly. During the consolidation or polymerization step, the assembly is subjected to a pressure and temperature cycle. In one operating mode, the different layers 132, 134, 134′ are dry and not pre-impregnated. In this case, during the consolidation or polymerization step, the fibers in the different fiber layers 132, 134, 134′ are embedded in a thermosetting resin during a resin transfer molding process.

On completion of this consolidation or polymerization step, the method comprises a step of demolding the hardened frame 118.1.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing an aircraft window frame, said frame comprising a first surface that has at least first and second faces extending about an entire perimeter of the aircraft window frame, said first and second faces being joined by a curved joining zone, said frame being made of a composite material comprising fibers embedded in a resin matrix, the manufacturing method comprising:
a step of assembling into an assembly, a reinforcement and a stack comprising a first layer positioned on the first surface and internal fiber layers, into a mold,
a step of consolidating or polymerizing the assembly, and
a step of demolding the aircraft window frame, the reinforcement having first and second peripheral edges, being interposed between the first layer on one side and the internal fiber layers on the other side, and being positioned in the joining zone, the first layer and the internal fiber layers extending on both sides of the reinforcement and being stacked on both sides of the reinforcement,
wherein during the step of assembling, at least a first seam is made to join at least the reinforcement and some fiber layers, the first seam comprising stitches offset, in a direction perpendicular to the first surface, in relation to the first surface at least in the first face and in the joining zone so that the stitches do not reach the first surface and are not visible from the first surface.

2. The method for manufacturing an aircraft window frame as claimed in claim 1, wherein the stitches of the first seam do not traverse any fiber layers between the reinforcement and the first surface, at least in the first face.

3. The method for manufacturing an aircraft window frame as claimed in claim 1,
wherein the aircraft window frame comprises at least one intermediate layer interposed between the first layer and the internal fiber layers, and
wherein the first seam traverses the reinforcement, the internal fiber layers and at least one intermediate layer and does not traverse the first layer.

4. The method for manufacturing an aircraft window frame as claimed in claim 1, wherein during the assembly step, at least a second seam is made, offset from the joining zone and from the first face, the second seam comprising through-stitches visible from the first surface.

5. The method for manufacturing an aircraft window frame as claimed in claim 1, wherein a barrier layer is positioned between the reinforcement and the first surface to cover the reinforcement and to form a barrier limiting a spread of resin toward the first surface.

6. The method for manufacturing an aircraft window frame as claimed in claim 1, wherein the method comprises a step of sprinkling a resin between the fiber layers and heating to a temperature below a polymerization or consolidation temperature to activate a tack of the resin in order to keep the fiber layers bonded together before the consolidation or polymerization step.

7. An aircraft window frame manufactured using the method as claimed in claim 1, said frame comprising:
a first surface that has at least first and second faces that extend about an entire perimeter of the aircraft window frame and that are joined by a curved joining zone,
said aircraft window frame being made of a composite material comprising fibers embedded in a resin matrix,
said aircraft window frame comprising a stack comprising a first layer positioned on the first surface and internal layers, as well as at least one reinforcement interposed between the first layer on one side and the internal layers on the other side, and positioned in the joining zone, the first layer and the internal layers extending on both sides of the reinforcement and being stacked on both sides of the reinforcement,
wherein the aircraft window frame comprises at least a first seam joining at least the reinforcement and some layers, the first seam comprising stitches offset, in a direction perpendicular to the first surface, in relation to the first surface at least in the first face and in the joining zone so that the stitches do not reach the first surface and are not visible from the first surface.

8. The aircraft window frame as claimed in claim 7, wherein the aircraft window frame comprises at least a second seam offset from the joining zone and from the first face, the second seam comprising through-stitches visible from the first surface.

9. The aircraft window frame as claimed in claim 7, wherein the stitches of the first seam do not traverse any fiber layers between the reinforcement and the first surface, at least in the first face.

10. The aircraft window frame as claimed in claim 7,
further comprising at least one intermediate layer interposed between the first layer and the internal layers, and
wherein the first seam traverses the reinforcement, the internal layers and the at least one intermediate layer and does not traverse the first layer.

11. The aircraft window frame as claimed in claim 7, wherein the aircraft window frame comprises at least one barrier layer covering the reinforcement, positioned between the reinforcement and the first surface and configured to form a barrier limiting a spread of resin toward the first surface.

12. An aircraft comprising at least one window frame as claimed in claim 7.
